(19) United States
(12) Patent Application Publication
(10) Pub. No.: US 2004/0267598 A1
(43) Pub. Date: Dec. 30, 2004

(54) Operating mechanism of monitoring the feedback of ordering through internet

(76) Inventor: Cooper S. K. Kuo, Taipei (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 10/608,035

(22) Filed: Jun. 30, 2003

(51) Int. Cl. G06F 17/60

(52) U.S. Cl. 705/10

(57) ABSTRACT

An operating mechanism of ordering monitor feedback through the internet, which is mainly to provide a web site by a company for the employee in that company, the consumer and the verified factory to login. The consumer login said web site could view the result of examining, testing, classification, rework, and repair and the analytic report that analyze the rate of inferior and the yield of each product except for proceeding ordering motion; if the employee of that company login such web site, it could be subdivided into the boss login or the general employee login, if the general login he could input the ordering number, upload the inferior data as well as view the result of examining, testing, classification, rework as well as repair.

### BACKGROUND OF THE INVENTION

1. Field of the Invention

This invention relates to an operation mechanism of monitoring the feedback of through internet, especially refer to providing a web site by the agent company which not only provides the ordering of the consumers but also let the consumers control the quality condition of their products being examinated, tested, classified, rework as well as after repair.

2. Description of the Prior Art

Conventional ordering to the fabrication vendors by the consumers usually tell the quality of the goods required on fabrication, after the goods are fabricated, next it is return to the consumers to proceed the action of quality assurance; if there is no inferior it completes the ordering of the goods. However, usually the consumers have no enough time to monitor the fabrication condition on the factory when the consumers trustee the foreigner factory to fabricate of the goods. So the consumers have to entrust a local quality assurance company to perform the quality assurance task such that the goods will be fabricated under good quality. This quality assurance company should face its consumers with honest, professional, fair, warm-hearted attitude. When the quality assurance company receive the ordering from the consumers, they will bring the product specification required by the consumers to perform the task of quality assurance of the goods in the factory and to complete the book data according to the result of quality assurance to fax or mail the foreign consumers so that the consumers will understand the reason why the yield or the inferior ratio of the goods; however, such way of communication is too slow that it is not conform to the current trends in modern era of which the technology makes progress so fast; so if we could perform ordering and transact mechanism through the internet, which inputs the results of quality assurance into the internet web so that the vendors, the consumers, as well as the factory will grasp the quality of the goods fabricated in time and further takes these results of inferior as the basis of betterment in research and development.

Thus it is clearly that the conventional one is not a good design and requires to be bettered; the inventor of this invention, however, after several years study, finally invents an operating mechanism of monitoring the feedback of ordering through internet of this invention.

### SUMMARY OF THE INVENTION

An object of this invention is to provide a web site which makes the ordering consumers could ordering through the internet wherein it inputs the data into said web site so that the company being trusted ordering will goes to the place being verified or tested of such products according to the consumers' instruction to proceed the task of testing, verification, classification, rework or repairing according to the consumers' requirements and to input such result of verification into such web site so that the consumers could see the reason of the yield or the rate of inferior of the goods through the internet login to monitor and control the quality of the goods arid to achieve the operating mechanism of ordering monitor feedback through the internet.

Another object of this invention is to provide an operating mechanism of which the factory being verified could see the result of quality assurance of the goods through the internet login and monitor the quality of the goods real time through the inferior analysis report and figures and achieves the ordering monitor feedback through the internet.

The operating mechanism of achieving the ordering monitor feedback through the internet of achieving the above-mentioned object of the invention is mainly provide a web site by a company so that the employee of said company, the consumers who orders and he factory being verified its product quality could login wherein the consumers could login said web site to input the ordering data to the company that provides the web site through the internet so that said quality assurance company could proceed the tasks of quality verification, checking, testing, classification, and repair of the goods by going to the factory assigned by the consumers and input such results into the web site so that the employee of the factory, the factory, the consumers could view such results of the rate of inferior and yield and to analyze and thus see the reason of inferior by login the web site. Besides, the boss could check the money of the whole entrust procedure to see the income of the company.

### BRIEF DESCRIPTION OF THE DRAWINGS

The drawings disclose an illustrative embodiment of the present invention which serves to exemplify the various advantages and objects hereof, and are as follows:

FIG. 1 is the schematic view of the operating mechanism of the ordering monitor feedback achieved through the internet of this invention;

FIG. 2 is the main flow diagram of the employee login of the company of the operating mechanism of the ordering monitor feedback achieved through the internet of this invention;

FIG. 2A is the A flow diagram of FIG. 1;

FIG. 2B is the B flow diagram of FIG. 1;

FIG. 2C is the C flow diagram of FIG. 1;

FIG. 2D is the D flow diagram of FIG. 1;

FIG. 3 is the flow diagram of the consumers login of the company of the operating mechanism of the ordering monitor feedback achieved through the internet of this invention;

FIG. 4 is the flow diagram of the factory login of the company of the operating mechanism of the ordering monitor feedback achieved through the internet of this invention;

FIG. 5 is the illustrative view of the results of the quality verification of the operating mechanism of the ordering monitor feedback achieved through the internet of this invention;

FIG. 6 is the illustrative view of the results of the quality verifier of the operating mechanism of the ordering monitor feedback achieved through the internet of this invention;

FIG. 7 is the illustrative view of the data of the inferior of the operating mechanism of the ordering monitor feedback achieved through the internet of this invention;

FIG. 8A and FIG. 8B are the analysis view of the yield and inferior of the operating mechanism of the ordering monitor feedback achieved through the internet of this invention;

FIG. 9 is the illustrative view of the results of the quality verification by the factory of the operating mechanism of the ordering monitor feedback achieved through the internet of this invention;

### DETAILED DESCRIPTION OF THE PREFERRED EMBODIMENT

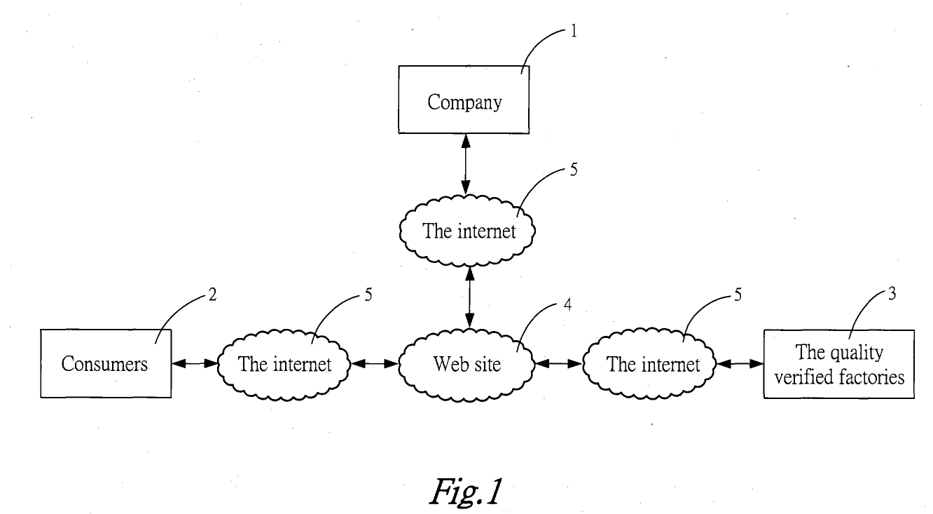

Please refer to FIG. 1, which is the operating mechanism of the ordering monitor feedback through the internet provided by this invention, wherein it is mainly a company 1 providing a login web site for login of the employee, the ordering consumers 2 and the factory 3 being qualified of their products through the internet 5 such that said company 1 sets up the web site 4 to become the media between the ordering consumers 2 and the factory being qualified 3. When the ordering consumers 2 login said web site 4 and input said ordering information to the company 1 that provides the web site through the internet 5 such that said company 1 become the media between the consumer of ordering 2 and the factory being quality verified. Besides, since said factory 3 is an unit being quality verified, it requires the agreement of the ordering consumers to login said web site 4 and check up the ratio of the yield and the inferior of the products manufactured. Meanwhile, all of them do not have to go to the scene themselves to have communications; in addition, the boss could understand the whole situation of income by the internet through checking the money received during the whole procedure.

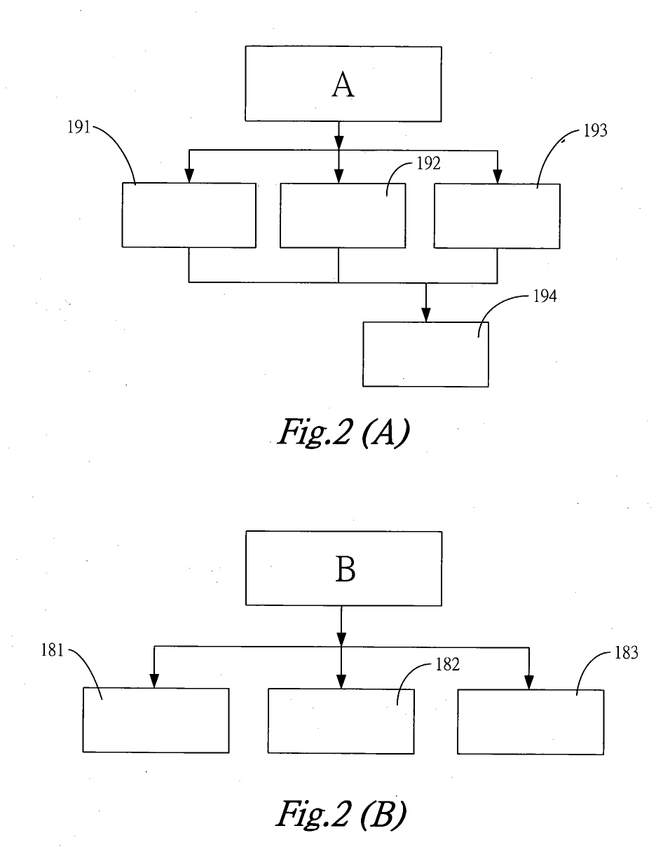

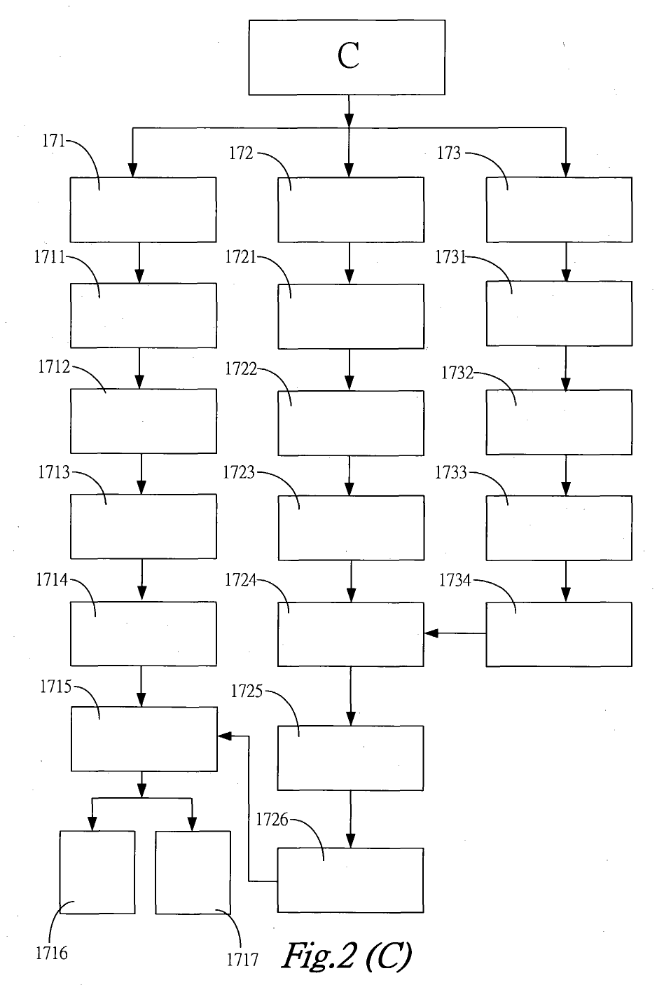

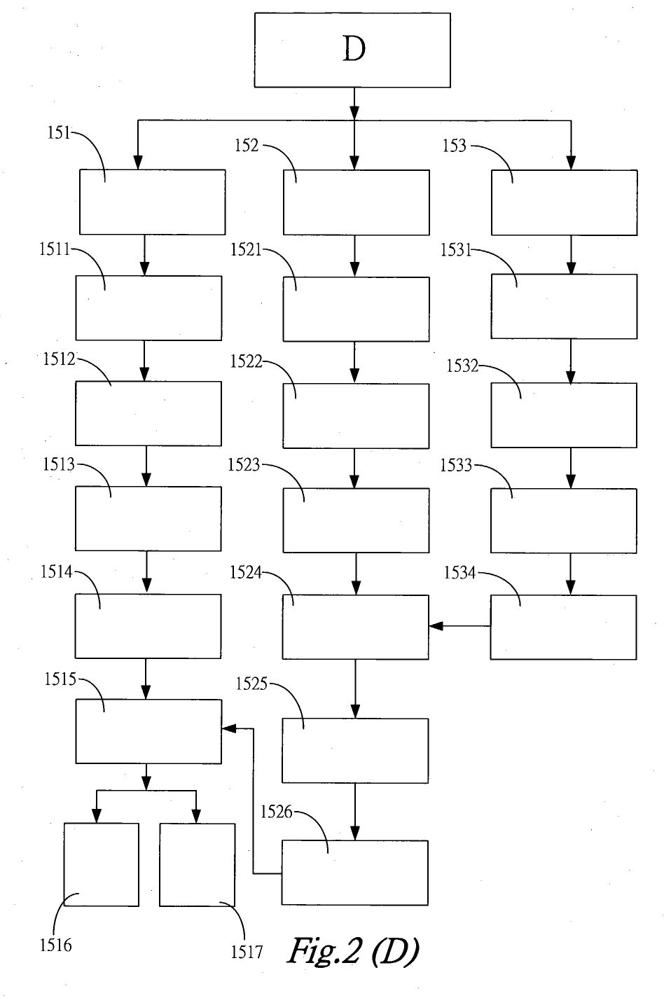

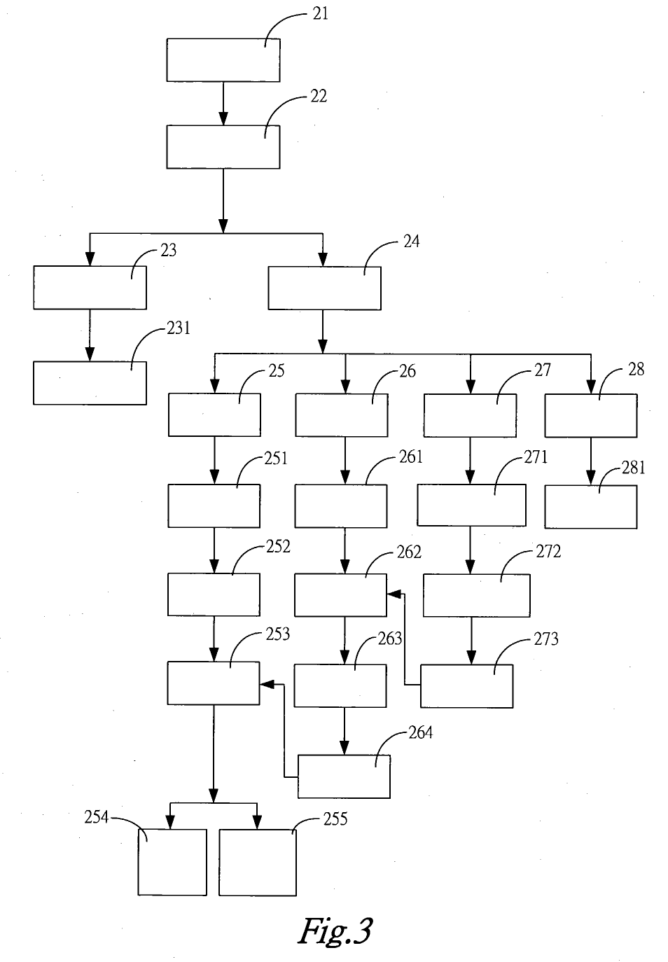

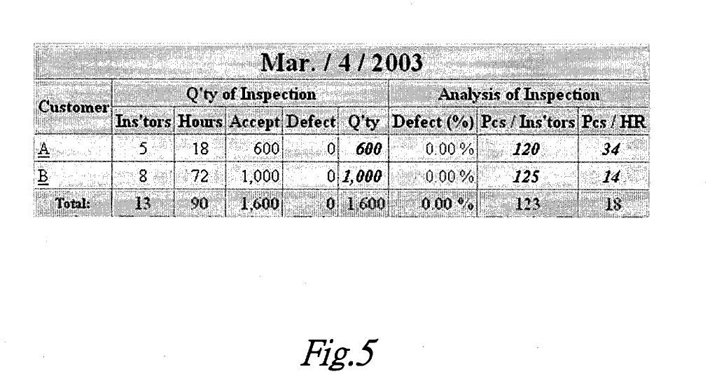

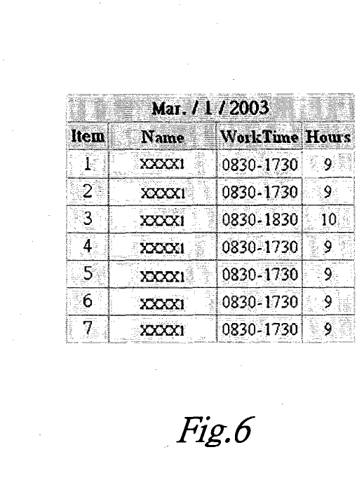

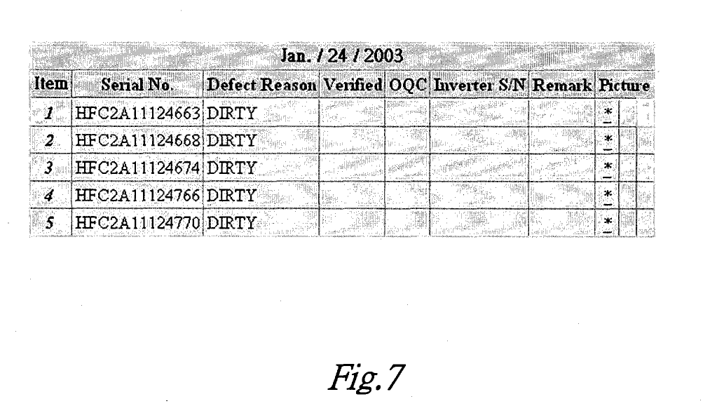

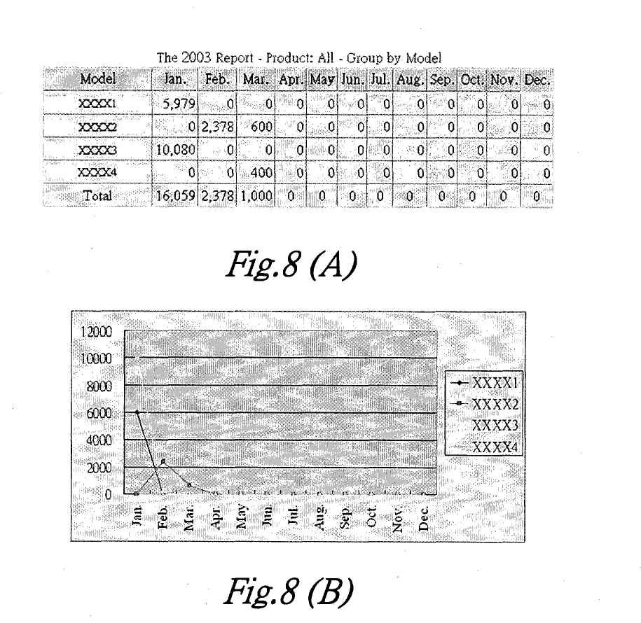

List below is the detail description when the consumers 2 is ordering toward the company 1 and the factory 3 being verified its quality login the web site 4; please refer to FIG. 2-FIG. 2D, which illustrates the flow diagram when the company login the web site; when the company login said web site 11, said web site will require the login user to enter the password; if the password is correct it is judged to be the login 12 of the company employee, next, to subdivide as the boss login 13 or the general employee login 14; if it belongs to a general employee login, said company employee could be next select further to check if there is any order information 20 of goods or he or she will input the ordering number 19 or upload the inferior data 18 or check-up the result of quality assurance 17. If the company employee want to input the order number 19, as shown in FIG. 2, the company employee could choose to input the result 192 of return approval data 191, the result of the product quality qualification 193; said return approval number data 191 is used as the basis for clear the duty or responsibility if the consumers ask for return of the goods; said result of quality qualification is the result of checking, testing, classification, rework, and repair comprising the date of quality qualification, goods type number, name of the verifier, number of the verifier, the working content, working date as well as time, the number of the goods being verified, the number of good vs. inferior products as well as the reason of inferior, etc; wherein the result of product verification 193 is through product sampling, which only input the result of input into the web site, when all the above-mentioned information is finish input, the name of the verifier 194 should also be input. If the employee of the company wants to upload the data of the inferior 18, as shown in FIG. 2B, when there are more inferior products, they could choose to upload the reason of the inferior products onto said web site 181 with the file wherein if the number is less they could input the data to the web site directly; also the employee could choose to upload the photo of the inferior products onto the web site directly for reference 183 of the consumers and the factory when they want to discuss the reason of the inferior products. If the employee of the company wants to look up the result of the quality verification 17, he could only see the result of the quality verification in his region as shown in FIG. 2C which could be subdivided into daily report 171, monthly report 172 as well as yearly report 173; when the user choose the daily report 171, he must first pick-up date 1711, next to look it up to see if there is any consumer to ordering at that day 1712, and he picks-up the consumer being queried 1713, next to select the consumer he wants to look at 1714 so that he could see the result of quality verification 1715 at that day of said consumer such as: the time of quality verification, the number of products, the number of inferior products, the total number, the rate of inferior, the number of the quality verification verified by each verifier, the number of products verification per hour, etc; as shown in FIG. 5, besides, he or she could also look up the data of the verifier 1716 as shown in FIG. 6 and the reason of the inferior and the figure 1717 as shown in FIG. 7; if the employee selects the monthly report 172, he or she will first select the month 1721 and then he or she will look up to see if there is any consumer to ordering 1722, next, select the consumer dsired to view 1723, next to select the quality verification report of that country 1724, which will show the date 1725 of which there performs products verification at that month, next to select the date desired to perform products verification 1726 such as the time of products verification, the number of good products, the number of the inferior products, the total numbers, the rate of inferior, the number of products being verified by each verifier, the number of products being verified per hour, etc. (See FIG. 5), next he or she could view the data of the verifier 1716 as shown in FIG. 6 as well as the reason of inferior and the figure 1717; if the employee selects the annual report 173, he or she will first select which year 1731, next to select the consumer 1732, which will show the report 1733 of the products verified at which month or which year, next he or she will select the month 1734, and looks it up the report 1724 of products verified of the foresee country, which will show the date 1725 of which there shows products verification at that month, next to select the date being product verification 1726 such as the time of product verification, the number of good products, the number of inferior products, the total number, the rate of inferior, the number of products being verified by each verifier, the number of products verified per hour as shown in FIG. 5, next he or she could view the data of the verifier 1716 as shown in FIG. 6, the reason why there produces the inferior products as well as their figures shown in FIG. 7.

Please refer to FIG. 2, which is the login flow diagram of the consumer of this invention, when the consumer login the web site, said web site will require the consumer to input the password; when it judges that the login user is their consumer 22, said consumer will have two choices, one is consumer ordering 23 and the other is to check-up the result of quality verification 24; if the consumer selects to ordering23, he or she should write down the ordering information 231 on the web site such as to input the date of products verification, the name of the products quality verification, the type of commercials, the number of products being verified its quality, the condition of inferior, the way of quality verification, the name of ordering company, their e-mail address and their tel no, fax, the factory info, factory address, factory contact person, factory contact tel, as well as the carbon copy of the ordering info; said quality verification comprises verification, testing, classification, repair, after the company being trusted receive the info of ordering, they will go to the factory according to the instruction of their clients to perform products verification task wherein the location could be the warehouse or the factory; and they will upload or input the verification results onto the web site for the remote login of the consumers.

When the ordering consumers wish to see the results of products verification, which could be subdivided as daily report 25, monthly report 26, yearly report 27 as well as analytic report 28, whatever the choice would be, they could only see the report verified in their own region ordering; when the consumers selects the daily report 25, they should first pick up the date 251 to view so that said web site will show which country said consumer entrust his products to be verified, next to select the country 252 according to the region, which also shows the result 253 of product verification such as the time, the number of good products, the number of the inferior products, the total number, the rate of inferior, the number of products verified per verifier, the number of products verified per hour, etc.(See FIG. 5), next he or she could view the data of the verifier 1716 as shown in FIG. 6 as well as the reason of inferior and the figure 1717; if the employee selects the annual report 271, he or she will first select which year, next to select the consumer, which will show the report 271 of the products verified at which month or which year, next he or she will select the month 272, and looks it up the report 273 of products verified of the foresee country, which will show the date of which there shows products verification at that month, next to select the date being product verification such as the time of product verification, the number of good products, the number of inferior products, the total number, the rate of inferior, the number of products being verified by each verifier, the number of products verified per hour as shown in FIG. 5, next he or she could view the data of the verifier as shown in FIG. 6, the reason why there produces the inferior products as well as their figures shown in FIG. 7. If the consumer selects the analysis report 28, he or she will see the analytical report of the products.

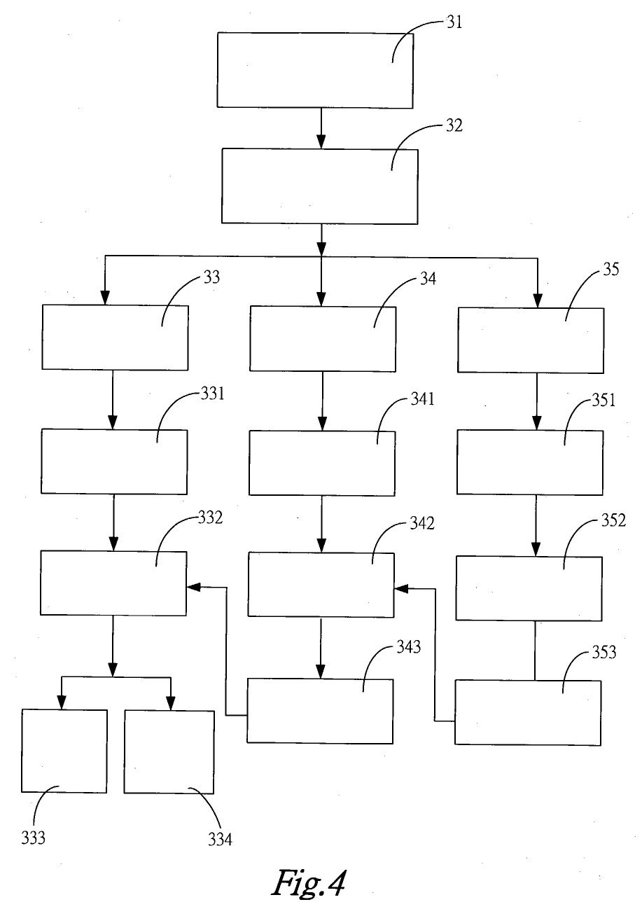

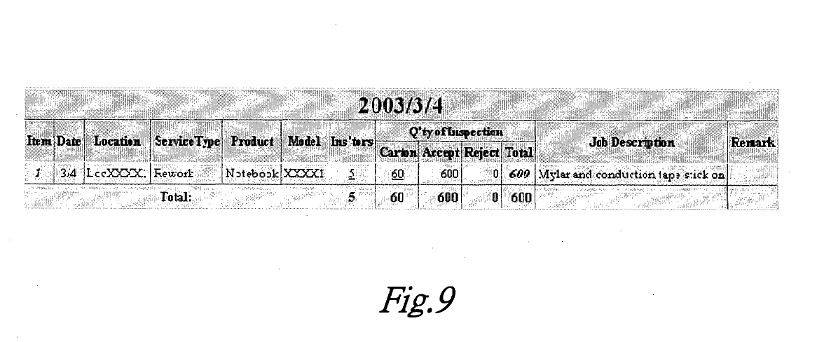

Please refer to FIG. 4, which is the flow diagram of the login of the verified factory, said factory is the unit being verified its product quality, so it will require the password with the agreement of their ordering consumers. When the factory login the web site 31, said web site will require the user to enter the password, when it judges that the login user is the factory login 32, said report of product verification could be subdivided into the daily report 33, the monthly report 34 and the annual report 35; whatever the factory selects which way of query, he could only see the data of the verified products; when the factory selects the daily report 33, he should pick up the date of view 331 which would display the result of product verification 332 such as the time of verification, the number of fine products, the number of inferior products, etc. (Shown in FIG. 9), next he would also view the data of the verifier 333 as shown in FIG. 6 and the reason of inferior of the inferior products and the figure 334 as shown in FIG. 7; if the factory selects the monthly report 34, he will first select the month 342, which will display the date 342 during each month, next to pick up the date 343 he wants to view, the result of products quality verification will then be displayed onto said web site, such as the time, the number of good products, the number of the inferior products, the total number, the rate of inferior, the number of products verified per verifier, the number of products verified per hour, etc.(See FIG. 5), next he or she could view the data of the verifier 1716 as shown in FIG. 6 as well as the reason of inferior and the figure 1717; if the employee selects the annual report 271, he or she will first select which year, next to select the consumer, which will show the report 271 of the products verified at which month or which year, next he or she will select the month 272, and looks it up the report 273 of products verified of the foresee country, which will show the date of which there shows products verification at that month, next to select the date being product verification such as the time of product verification, the number of good products, the number of inferior products, the total number, the rate of inferior, the number of products being verified by each verifier, the number of products verified per hour as shown in FIG. 5, next he or she could view the data of the verifier as shown in FIG. 6, the reason why there produces the inferior products as well as their figures shown in FIG. 7.

The operating mechanism of the ordering monitor feedback through the internet provides by this invention has the following advantages in comparison with the other conventional technologies:

1. This invention provides a web site so that the consumer input said ordering information onto the web site through the internet such that the ordering company will proceed the commercial verification by going to the factory being verified according to the consumer's instruction and to input said result of product quality verification inot said web site so that the consumer could login said web site through the internet to check to see the yield or the rate of inferior of said commercial products through the internet as well as the inferior as if he or she is on the scene.

2. This invention provide a web site for the factory being verified its fabricated commercial products to login said web site to view its condition of inferior products himself fabricated checked by the password acquired only with the agreement of the consumer.

3. This invention provides a web site so that the boss being entrusted could login said web site to check the result of the commercials and the financial report through login the internet.

Many changes and modifications in the above described embodiment of the invention can, of course, be carried out without departing from the scope thereof. Accordingly, to promote the progress in science and the useful arts, the invention is disclosed and is intended to be limited only by the scope of the appended claims.

What is claimed is:

1. An operating mechanism of ordering monitor feedback achieved through the internet for the employee in the company, the consumer that orders, and the factory to login said web site through the internet such that said company become the media between the ordering consumer and the factory through the setting up of the internet; said ordering consumer could login said web site through login the internet and inputs the ordering information to the company that provides the web site directly on the web site, said company will come to the place where it was assigned by the consumer according to the ordering information input by the consumers and to input said result of product quality verification and the data of the verifier onto said web site through the internet so that remote consumer, company employee, as well as the factory being verified its fabricated products will login said web site anytime to check and view the condition of such products to better the quality of the commercial products according to the yield and the rate of inferior by improving the condition of fabrication.

2. The operating mechanism as mentioned in claim 1, wherein if the login user is the boss of that company, despite of looking at the result of the product quality verification, he also has the right to look into the unit price of that products as well as the total amounts of money on such entrust business to understand the income of that company.

3. The operating mechanism as mentioned in claim 1, wherein said employee of that company, the ordering consumer, and the factory being verified his fabricated product should input an identification password on login, through such identification password it could recognize the i.d. of the user, besides, the factory could only have their identification password upon the agreement of their ordering consumers.

4. The operating mechanism as mentioned in claim 1, wherein if it is judged that the login user is the company employee, it could check up to see if there is any ordering information or it can query the result of the quality verification of the products through input the ordering number or uploading the inferior goods information.

5. The operating mechanism as mentioned in claim 1, wherein if it is judged that the login user is the consumer, he could only perform the input of the ordering information as well as to query the result of the quality verification of the entrust products.

6. The operating mechanism as mentioned in claim 1, wherein said verified could be a factory, when the web site judgment judges that the user is a verifier, said verifier could only view its own verification report of his verified products.

7. The operating mechanism as mentioned in claim 1, wherein when said company, the verified looks at the result of the quality verification of the products, said report could be sub-classified as the daily report, the monthly report as well as the annual report.

8. The operating mechanism as mentioned in claim 1, wherein when said company, the verified looks at the result of the quality verification of the products, said report could be sub-classified as the daily report, the monthly report, the annual report as well as analysis report.

9. The operating mechanism as mentioned in claim 1, wherein the content of said quality verification comprises examining, testing, classification, rework or repair, whereas the job content comprises the time of examine, the number of fine products, the number of inferior products, the total number, the rate of inferior, the number of products examined for each verifier, the number of product verification per hour, etc; and it could view the verifier data, the inferior damage data as well as the figure in the result of the product verification.

10. The operating mechanism as mentioned in claim 1, wherein the verifier could be the warehouse of that ordering consumer.
